(19) United States
(12) Patent Application Publication
(10) Pub. No.: US 2016/0218455 A1
(43) Pub. Date: Jul. 28, 2016

(54) HYBRID ELECTRICAL CONNECTOR FOR HIGH-FREQUENCY SIGNALS

(71) Applicant: Samtec, Inc., New Albany, IN (US)

(72) Inventors: Edward P. SAYRE, Marshfield, MA (US); Norman Scott MCMORROW, Falmouth, ME (US); Chadrick Paul FAITH, Corydon, IN (US); Keith Richard GUETIG, Louisville, KY (US); Brian Richard VICICH, Goshen, KY (US); Eric Jean ZBINDEN, Sunnyvale, CA (US); William J. KOZLOVSKY, Sunnyvale, CA (US)

(21) Appl. No.: 14/845,990

(22) Filed: Sep. 4, 2015

Related U.S. Application Data
(60) Provisional application No. 62/136,059, filed on Mar. 20, 2015.
(60) Provisional application No. 62/107,671, filed on Jan. 26, 2015.

(51) Int. Cl. H01R 12/72; H01R 13/6592

(52) U.S. Cl. CPC H01R 12/72; H01R 13/6592

(57) ABSTRACT

A connector system includes a substrate; a first connector connected to the substrate and including a first housing, a second housing, and a cage surrounding the first and second housings; first cables connected to the second housing and the substrate; first contacts located in the first housing and directly connected to substrate; and second contacts located in the first housing and connected to the first cables.

### BACKGROUND OF THE INVENTION

1. Field of the Invention

The present invention relates to electrical connectors. More specifically, the present invention relates to high-frequency electrical connectors that include connections to cables and a circuit board.

2. Description of the Related Art

Electrical connectors are used to allow electrical devices, such as substrates or printed circuit boards (PCBs), to communicate with one another. Electrical connectors are also used along the path between electrical devices to connect cables to other cables or to PCBs. A connector may be thought of as having two portions, a first portion which connects to a first electrical device or a first cable and a second portion which connects to a second electrical device or a second cable, to be put into communication with the first device or first cable. To connect the two electrical devices or cables, the first and second portions of the connector are mated together.

A connector can include one set of contacts in the first portion and a second set of contacts in the second portion to be connected with the contacts of the first portion. This can be readily accomplished by providing a male connector and a female connector with corresponding sets of contacts that engage when the male and female connectors are mated. Further, the male and female connectors can be connected and disconnected from each other to respectively electrically connect and disconnect the electrical devices to which they are connected.

Accordingly, the first and second connector portions are connected to an electrical device or cable through its contacts. The contacts are typically permanently connected to the electrical device or cable. For example, the first connector portion can be connected to a cable, and the second connector portion can be connected to a PCB. The first connector portion can be connected to the second connector portion to allow transmission of signals to and from devices on and/or in the PCB. The second connector portion is connected to devices on and/or in the PCB with electrical traces etched in the PCB.

Various standards and specifications have been proposed and implemented for electrical connectors that transmit high-frequency signals. One example is Quad Small Form-factor Pluggable (QSFP), which is a specification for compact, hot-pluggable transceivers typically used in data communication systems. FIG. 1 is a perspective view of a conventional QSFP connector disclosed in U.S. Pat. No. 8,842,952, which is limited to a data transfer rate of about 10 Gbit/sec per channel (about 40 Gbit/sec total).

As shown in FIG. 1, a mating cable 4 is connected to a male QSFP connector 1, which mates with a female QSFP connector 2A included in a cage 2 mounted to a PCB 5. The male QSFP connector 1 includes a housing 1A and a circuit board 10. The cage 2 of the female QSFP connector 2A includes a heat sink 3. Input signals from the mating cable are transmitted between the connectors 1 and 2A and then transmitted to the PCB 5. The signals are then transmitted through electrical traces (not shown) in or on the PCB 5. For example, the signals may be transmitted through the electrical traces in the PCB 5 to an integrated circuit (IC) or other electrical components. However, this arrangement results in a bottleneck for data transmission due to the female QSFP connector 2A being terminated to the PCB 5.

FIG. 2 is a graph comparing the signal loss through a cable and the signal loss through traces on a PCB 5. As shown in FIG. 2, even a “low loss” etching for an electrical trace in a PCB has a significantly greater signal loss as compared with an equivalent length of #28 AWG (American wire gauge) cable, especially at higher frequencies. For example, at a frequency of 20 GHz, there is an approximately 36 dB difference in the signal loss for transmission through a cable as compared with transmission through an electrical trace in a PCB.

Thus, whereas the cable provides a signal path with high signal integrity (for example, an optical cable or shielded cable such as a coaxial cable or twinaxial cable), the electrical traces in the PCB provide a signal path with a lower signal integrity, especially at higher frequencies. In particular, electrical traces in the PCB have much higher loss than an optical or shielded cable and are far more susceptible to interference and cross-talk, even if components such as ICs are arranged on the PCB to be close to the female QSFP connector 2A.

### SUMMARY OF THE INVENTION

To overcome the problems described above, preferred embodiments of the present invention provide an electrical connector connected to a substrate that uses low-speed connections connected to electrical traces in the substrate for low-frequency signals, ground, and power, and that uses high-speed connections connected to cables for high-frequency signals. In other words, a connector according to preferred embodiments of the present invention is a hybrid connector with cable connections for high-frequency signals and board connections for other signals.

A connector system according to a preferred embodiment of the present invention includes a substrate; a first connector connected to the substrate and including a first housing, a second housing, and a cage surrounding the first and second housings; first cables connected to the second housing and the substrate; first contacts located in the first housing and directly connected to substrate; and second contacts located in the first housing and connected to the first cables.

The connector system preferably further includes third contacts located in the first housing and connected to ground. Preferably, the first cables have shields, and the third contacts are connected to the shields.

The first connector preferably further includes a weld tab. The connector system further preferably includes third contacts located in the first housing and connected to ground, and a grounding pin connected to one of the third contacts and the weld tab. The weld tab is preferably located in the first and second housings.

The second contacts are preferably directly connected to the first cables.

The connector system further preferably includes an IC located on the substrate. The first cables are preferably connected to the substrate next to the IC. The connector system further preferably includes an IC connector located on the substrate next to the IC. The first cables are preferably connected to the IC connector.

The first connector is preferably compatible with QSFP specifications.

The connector system further preferably includes a second connector and second cables connected to the second connector. The connector system further preferably includes a first IC, a first IC connector, a second IC, and a second IC connector. Preferably, at least one of the first cables is connected to the first IC connector; at least one of the first cables is connected to the second IC connector; at least one of the second cables is connected to the first IC connector; and at least one of the second cables is connected to the second IC connector.

The first connector preferably is a vertical connector. The second contacts are preferably connected to the first cables through a connector substrate. The second housing preferably includes one of an edgecard connector, an edge-rate connector, or pin-and-socket connector.

The above and other features, elements, steps, configurations, characteristics and advantages of the present invention will become more apparent from the following detailed description of preferred embodiments of the present invention with reference to the attached drawings.

### BRIEF DESCRIPTION OF THE DRAWINGS

FIG. 1 is a perspective view of a conventional QSFP connector.

FIG. 2 is a graph comparing the signal loss through a cable and the signal loss through traces on a printed circuit board (PCB).

FIGS. 3A and 4A are front and rear perspective views of a connector according to a preferred embodiment of the present invention.

FIGS. 3B and 4B are front and rear perspective views of a connector according to another preferred embodiment of the present invention.

FIG. 5 is a front view of the connector shown in FIGS. 3A and 4A.

FIGS. 6 and 7 are front and rear exploded perspective views of the connector shown in FIGS. 3A and 4A.

FIGS. 8A and 8B are cross-sectional views of the connector shown in FIGS. 3A and 4A.

FIGS. 9A and 9B are cross-sectional views of ground connections for the connector shown in FIGS. 3A and 4A.

FIGS. 9C-9F shows views of a grounding pin that can be used with the connector shown in FIGS. 3A and 4A.

FIG. 10 is a schematic cross-sectional view of the connector shown in FIGS. 3A and 4A.

FIGS. 11 and 12 are top and bottom perspective views of the connections between twinaxial cables and the contacts of the connector shown in FIGS. 3A and 4A.

FIGS. 13A and 13B are close-up perspective views of one section of contacts shown in FIG. 11.

FIG. 14 is a diagram showing a method of assembly for an integrated PCB assembly.

FIG. 15A is a perspective view of the connector shown in FIGS. 3A and 4A attached to a PCB that includes a panel, an integrated circuit, and an integrated circuit connector.

FIG. 15B is a perspective view of the connector shown in FIGS. 3B and 4B attached to a PCB that includes a panel, an integrated circuit, and an integrated circuit connector.

FIG. 16A is a perspective view of two of the connectors shown in FIGS. 3A and 4A attached to a PCB that includes two integrated circuits and two integrated circuit connectors.

FIG. 16B is a perspective view of two of the connectors shown in FIGS. 3B and 4B attached to a PCB that includes two integrated circuits and two integrated circuit connectors.

FIGS. 17 and 18 are top and bottom perspective views of the connector shown in FIGS. 3A and 4A arranged to mate with a male QSFP or similar connector.

FIGS. 19A and 19B show the connector shown in FIGS. 3B and 4B with an edge card connector interface.

FIGS. 20A and 20B show the connector shown in FIGS. 3B and 4B with an edge rate connector interface.

FIGS. 21A and 21B show the connector shown in FIGS. 3B and 4B with a pin and socket connector interface.

FIGS. 22A and 22B show the connector in FIGS. 3B and 4B with a heat sink.

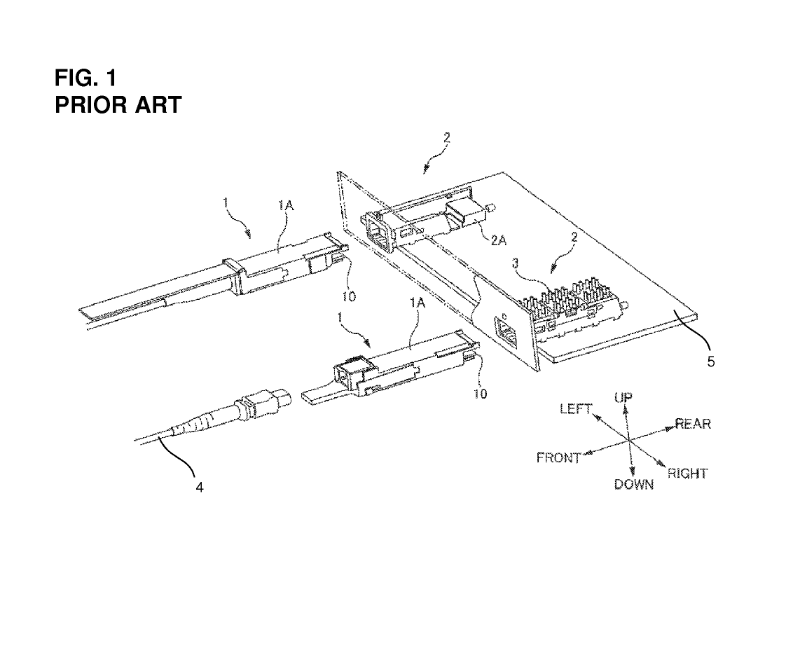

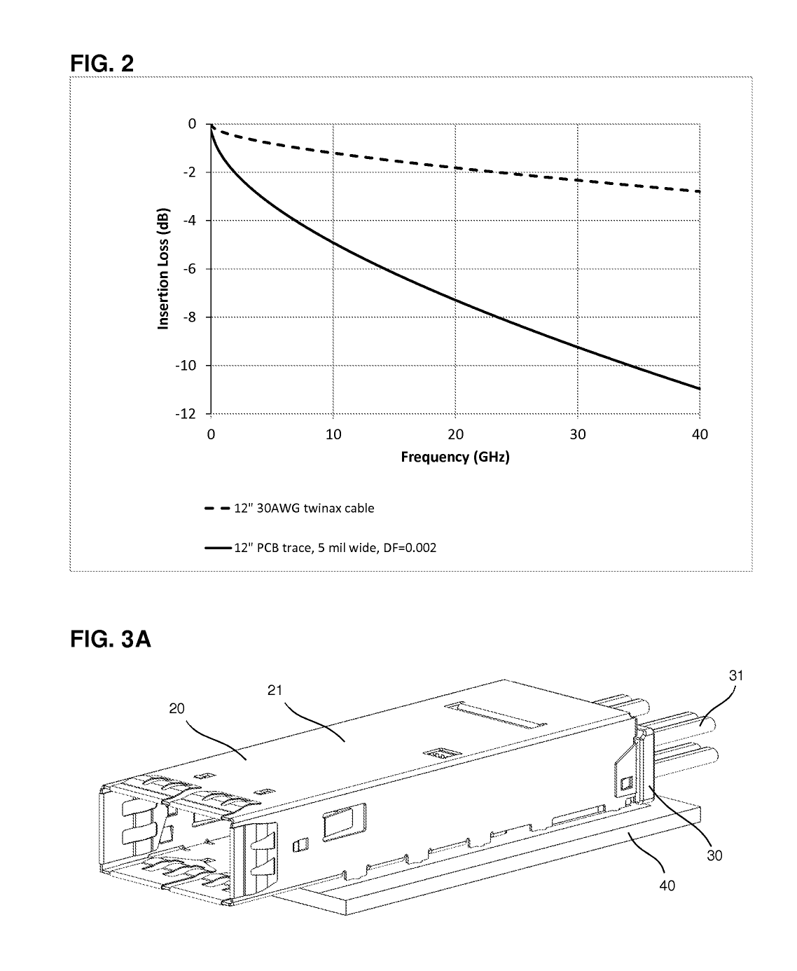

### DETAILED DESCRIPTION OF PREFERRED EMBODIMENTS

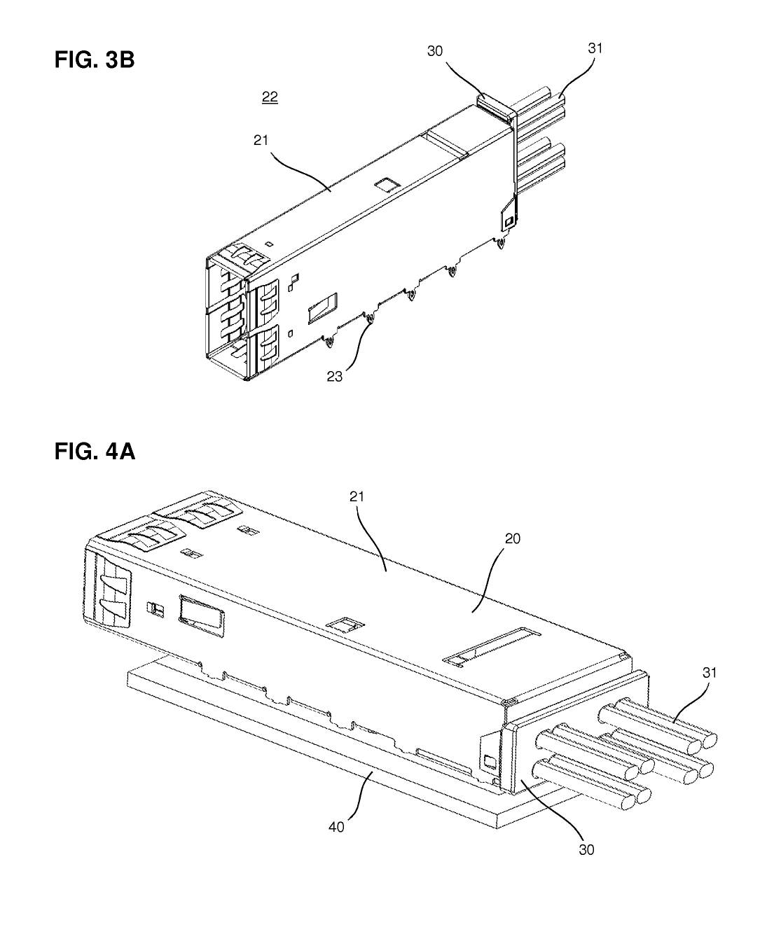

Preferred embodiments of the present invention will now be described in detail with reference to FIGS. 3A to 22B. Note that the following description is in all aspects illustrative and not restrictive and should not be construed to restrict the applications or uses of the present invention in any manner.

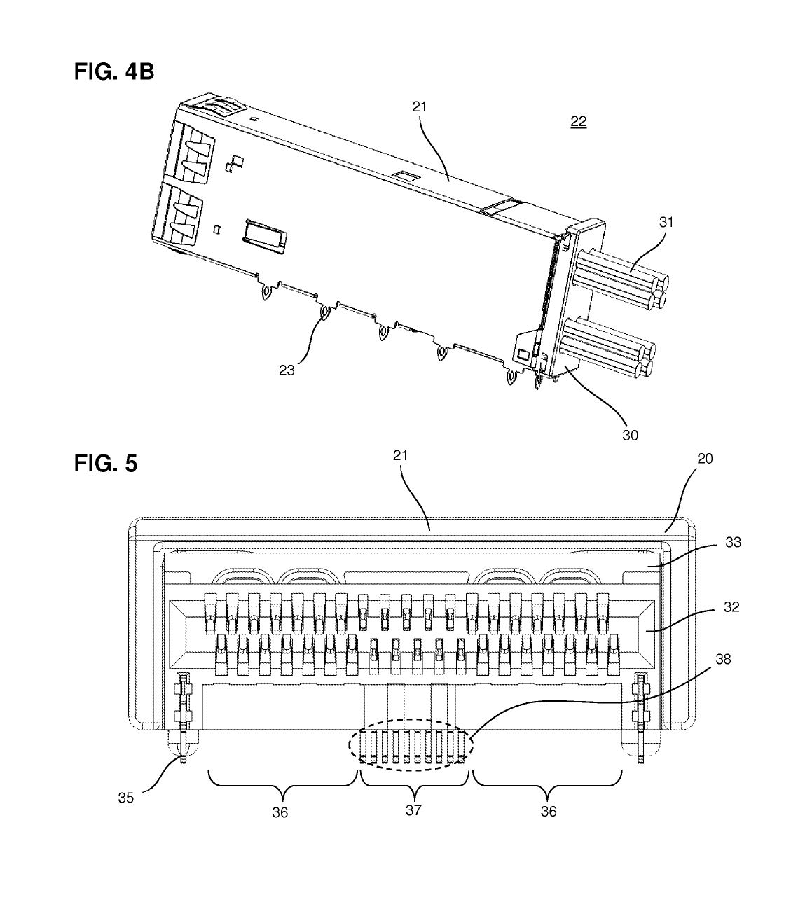

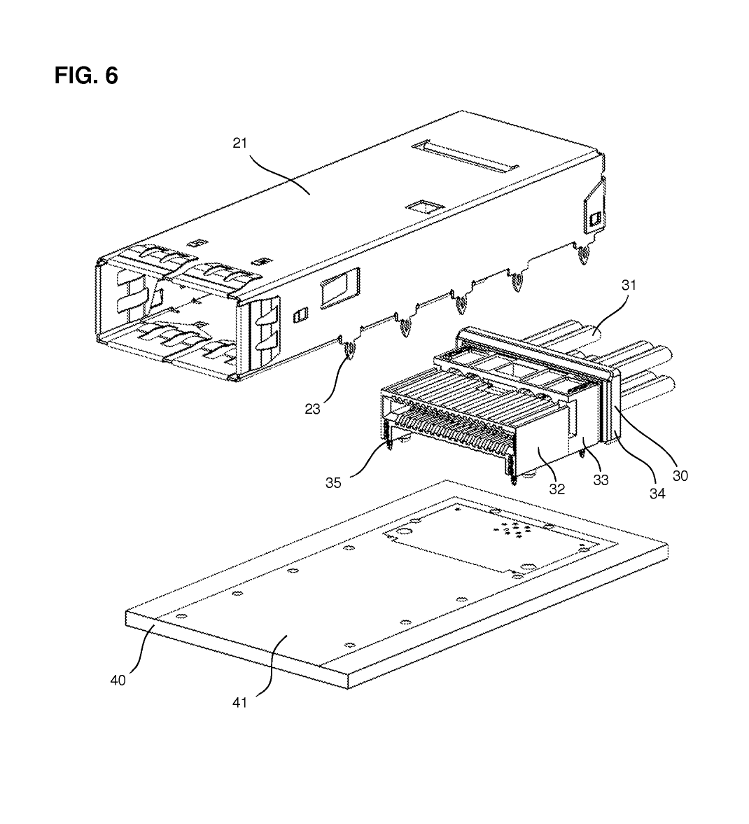

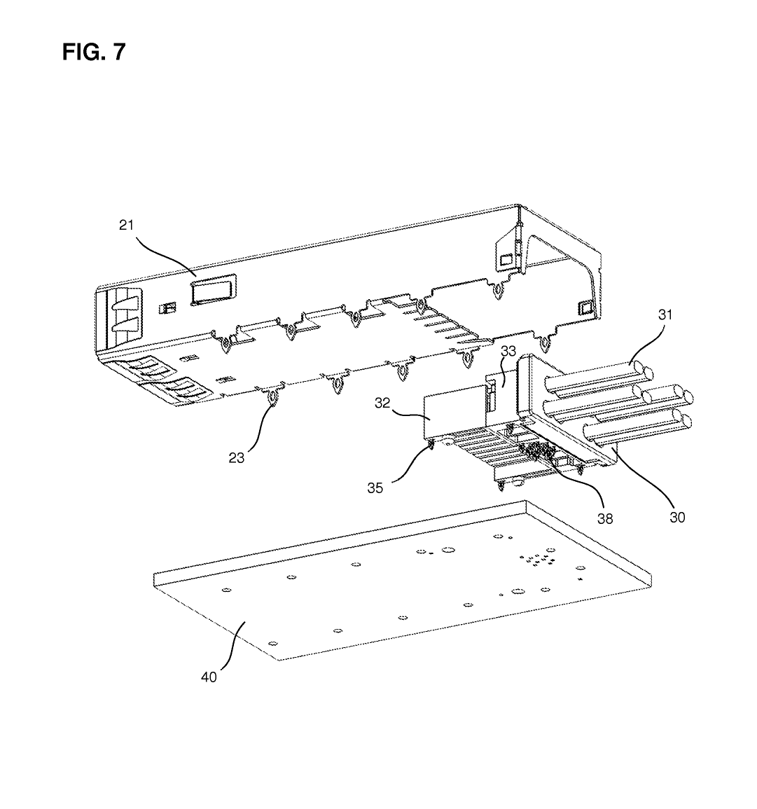

FIGS. 3A and 4A are front and rear perspective views of a connector 20 according to a preferred embodiment of the present invention. FIG. 5 is a front view of the connector 20 shown in FIGS. 3A and 4A. FIGS. 6 and 7 are front and rear exploded perspective views of the connector 20 shown in FIGS. 3A and 4A.

FIGS. 3B and 4B are front and rear perspective views of a connector 22 according to another preferred embodiment of the present invention. The connector 22 shown in FIGS. 3B and 4B is similar to the connector 20 shown in FIGS. 3A and 4A, except that the connector 22 shown in FIGS. 3B and 4B is a vertical connector.

The description below with respect to the connector 20 shown in FIGS. 3A and 3B is also applicable to the connector 22 shown in FIGS. 3B and 4B. A vertical connector 22 uses less space on a PCB or substrate, increases the optical module density for a front panel, works with both optical and electrical connectors, has equal thermal dissipation if more than one vertical connector is used, and works with existing optical connectors such as QSFP, etc.

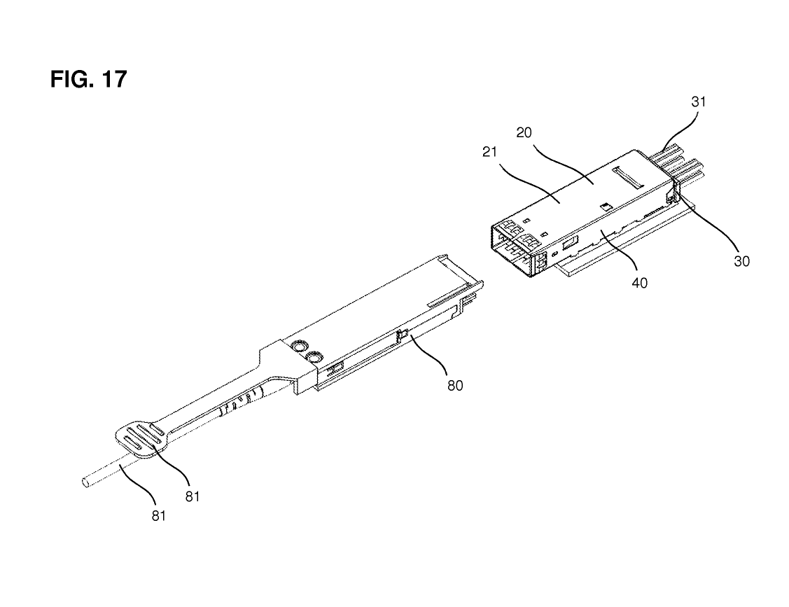

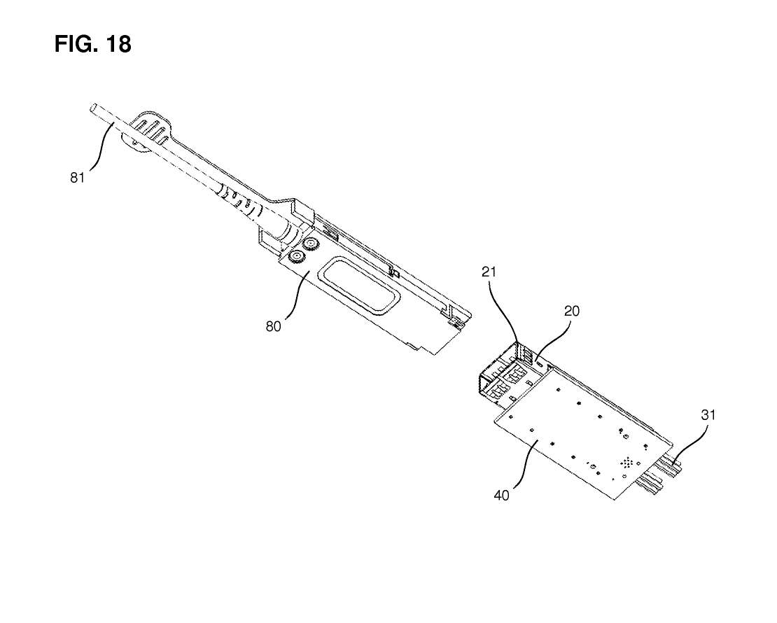

As shown in FIGS. 3A, 4A, and 5-7, the connector 20 includes a connector body 30 with a first housing 32 and a second housing 33. The first housing 32 includes contacts 24, 36, 37. Contacts 24 are preferably ground contacts, contacts 36 are preferably high-frequency contacts, and contacts 37 are preferably low-frequency contacts. Cables 31 extend from the second housing 33. A cage 21 surrounds the first and second housings 32, 33 and receives a corresponding connector (shown as mating connector in FIGS. 17 and 18). Preferably, the first housing 32, the second housing 33, and the cage 21 are mounted to a substrate 40, for example, a PCB, but other suitable substrates could also be used. The first housing 32, the second housing 33, and the cage 21 include edge pins 35 and cage pins 23 that mate with corresponding mounting holes in the substrate 40 to mechanically secure the connector 20 to the substrate 40. The edge pins 35 and the cage pins 23 can also provide a ground connection to a ground plane 41 or a ground trace in the substrate 40. Further, the connector 20 includes central pins 38 that mate with corresponding mounting holes in the substrate 40 to provide board connections to the substrate 40 that can transmit control signals, that can provide a power connection, that can provide a ground connection, or the like.

The second housing 33 provides strain relief for the cables 31, and the cage 21 provides a chassis ground connection for the connector 20 and is preferably in direct contact with the second housing 33 to help secure the connector 20 to the substrate 40. Preferably, the cage pins 23 engage with a ground plane 41 included in or on the substrate 40. The second housing 33 preferably includes a grommet 34 at an end of the second housing 33 that is opposite to the first housing 32. The grommet 34 is preferably an electromagnetic interference (EMI) grommet that is connected to the cage 21 and that can additionally be connected to the shields 39 of the cables 31. Preferably, the grommet 34 is molded to provide a secure, snap fit over the second housing 33 and/or to be inserted into the second housing 33.

Preferably, the connector 20 is a female-type connector. Although the connector 20 is shown as a QSFP connector, other connector/cable types may be used, including, for example, SAS/Mini SAS, HD Mini SAS, CX4, InfiniBand, SATA, SCSI, QSFP+, SFP+/SFP, HDMI Cable, USB Cable, Displayport Cable, CDFP, and the like. Preferably, the first housing 32 is configured so that it is compatible with male-type FSP or QSFP connectors.

The cables 31 are preferably shielded electrical cables, for example, coaxial cables, twinaxial cables, triaxial cables, twisted pairs, flexible printed circuits, flat flexible circuits, etc. The cables are preferably arranged as differential-pair, twinaxial cables, for example. Preferably, the cables 31 connect to the substrate 40 at a distance of less than about 5 mm or about 10 mm from the IC, for example, limiting the length of the associated traces. Further, the length of the signal path through the cables 31 for high-speed signals is preferably longer than the length of the signal path though the substrate 40 to limit the distance through high-loss signal paths. The longer cables 31 allow for the high-speed signals to be transmitted over longer distances over the top of the substrate 40 than if the high-speed signals where transmitted through high-loss signal paths such as traces on or within the substrate, and the longer cables 31 allow for greater design freedom in locating any IC that receives or transmits the high-speed signals further away from the connector 20.

The connector 20 is configured so that a mating connector 80, as shown in FIGS. 17 and 18 is able to engage with the contacts 24, 36, 37 of the connector 20. The mating connector 80 is attached to a mating cable 81 that can be used to connect an integrated PCB assembly with other components that form a complex electrical system, such as a computer, router, switching network, PCB control assembly, or other suitable electrical systems. The mating cable 81 can be, for example, a passive electrical cable, a shielded electrical cable, or an active optical cable. One example of a mating connector 80 is shown in FIGS. 17 and 18. As shown in FIGS. 17 and 18, the connector 20 can mate with, for example, a male QSFP connector, i.e., mating connector 80, with an attached mating cable 81. However, any similar connector may be used.

Preferably, as shown in FIG. 5, the connector preferably has 38 total contacts 24, 36, 37, for example, to comply with the QSFP specification, where 28 contacts 24, 36 are designated for high-speed data transmission (i.e., 4 channels, each with 4 signal contacts 36 and 3 return ground contacts 24), and the remaining 10 contacts 37 are designated for power transmission and low-frequency control signals. However, other numbers and arrangements of contacts can be used.

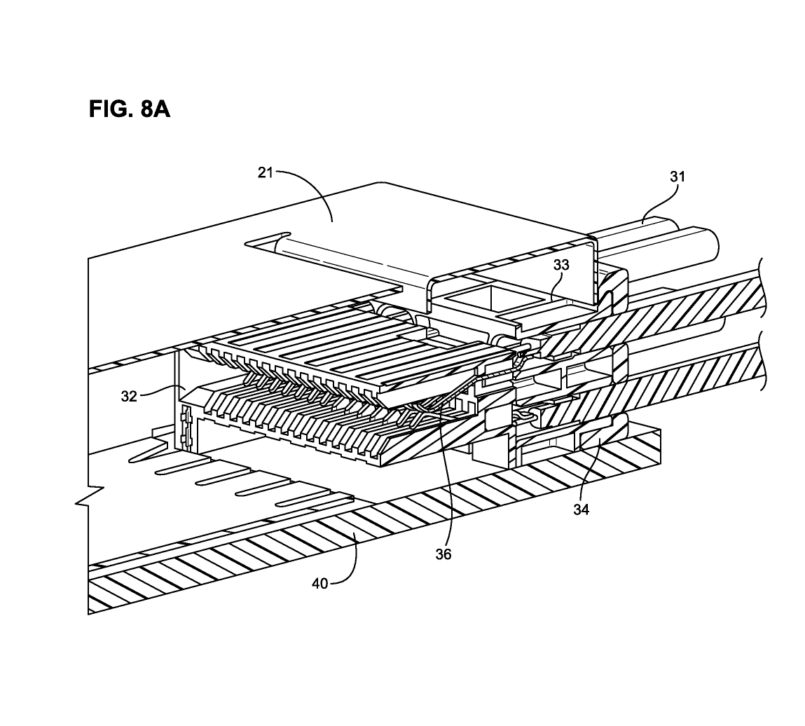

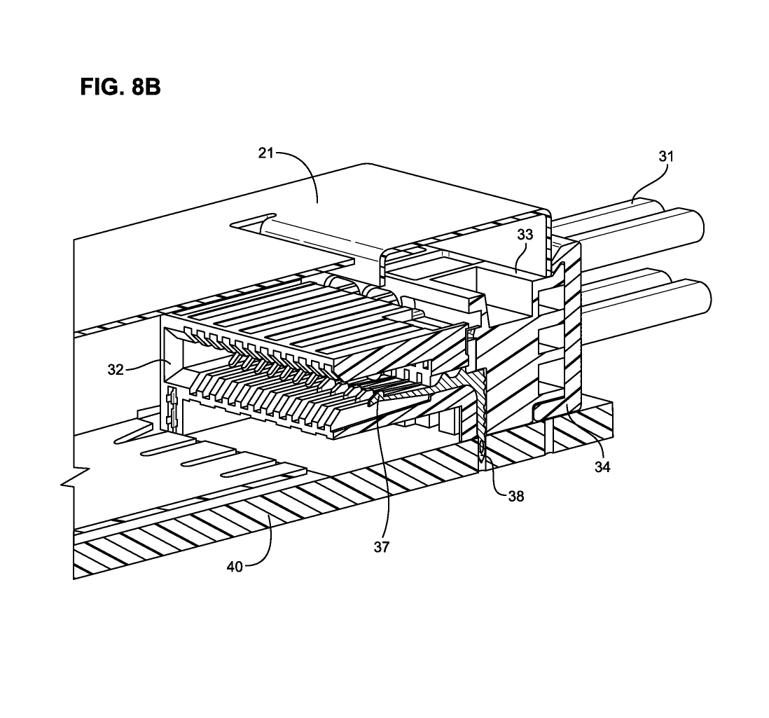

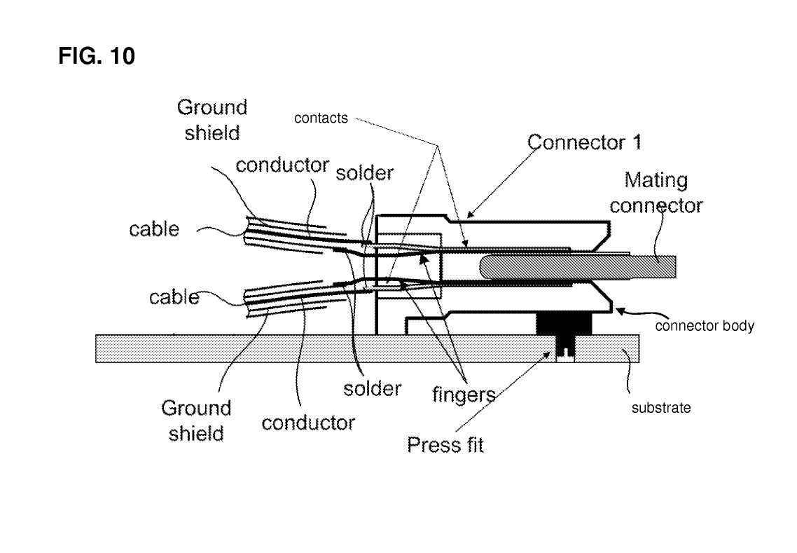

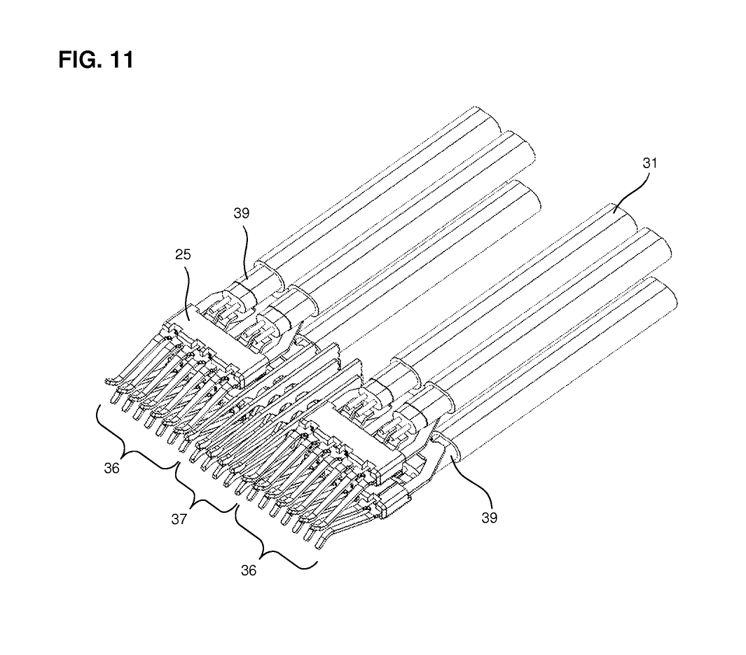

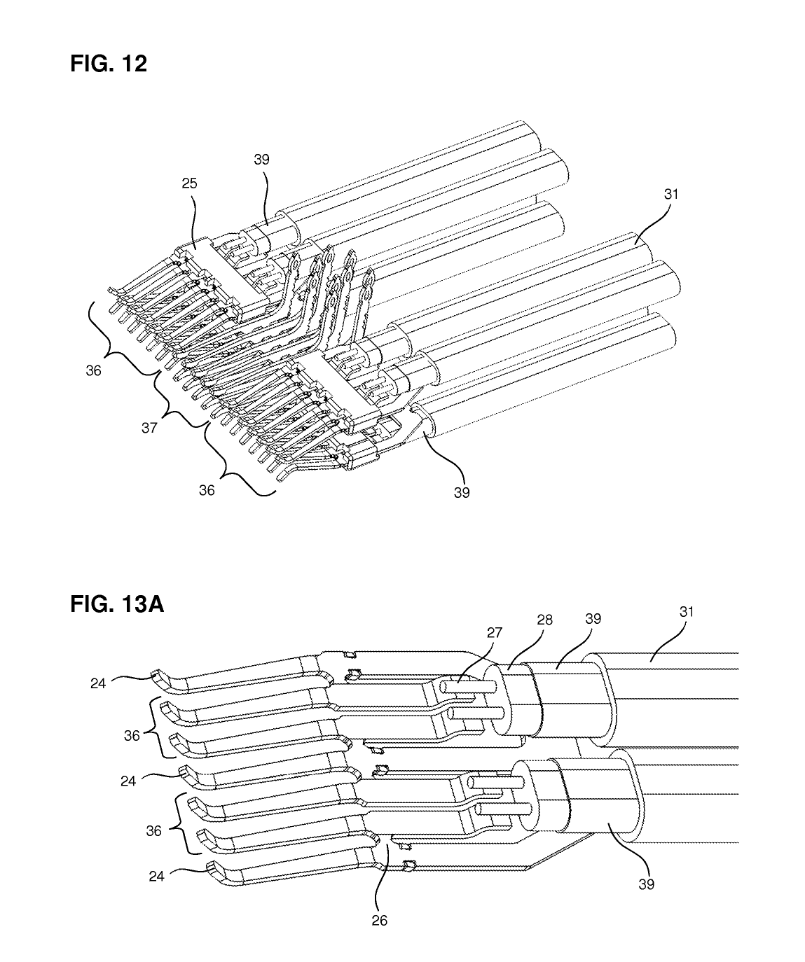

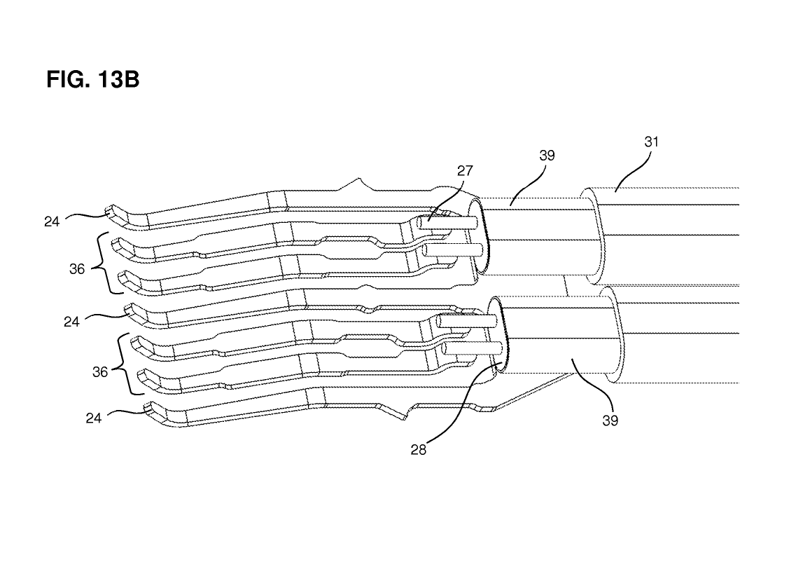

FIGS. 8A, 8B, 9A, 11, and 12 are cross-sectional views of the connector 20 shown in FIGS. 3A and 4A. FIG. 10 is a schematic cross-sectional view of the connector shown in FIGS. 3A and 4A. FIGS. 11 and 12 are top and bottom perspective views of the cable connections between cables 31 that are shown as twin axial cables and the contacts 24, 36 of the connector 20 shown in FIGS. 3A and 4A. For clarity, the first housing 32, the second housing 33, the cage 21, and substrate 40 are not shown in FIGS. 11 and 12. FIGS. 13A and 13B are close-up perspective views of one section of contacts shown in FIG. 11.

FIGS. 8A and 10-13B show the cable connection between some of the contacts 24, 36 of the connector 20 and the conductor 27 of a corresponding cable 31. Preferably, these cable connections are used to transmit high-frequency signals, but may also be used to transmit low-frequency signals, power, etc. The cables 31 are preferably twinaxial cables, which include two center conductors 27 surrounded by a shield 39 and an insulator 28 disposed between the two center conductors 27 and the shield 39. The cables 31 are preferably used with differential signaling to provide a high degree of signal integrity.

Preferably, the connection between the contacts 24, 36 and the cables 31 is a fusible connection provided by lead-free solder, using a typical reflow soldering process. However, the contacts 24, 36 and the cables 31 may also be connected by hand soldering, lead based solders, crimping, ultrasonic welding, and the like.

As shown in FIGS. 13A and 13B, the contacts 24, 36 are preferably configured so that the contacts 24, 36 that are connected to the center conductors 27 of the cable 31 have an adjacent contact 24 that is connected to ground. This allows the electrical paths through the connector 20 to be impedance-matched to the shielded electrical cable 31 and helps to minimize cross-talk between adjacent channels transmitted in adjacent electrical paths. Each high-frequency channel preferably includes two shielded cables 31, one for transmitting and one for receiving. As shown in FIGS. 13A and 13B, a ground connection is preferably included between the transmitting and receiving channels. Preferably, the contacts 24, 36 are initially connected by tie bars 26, as shown in FIG. 13A, to provide a rigid structure that structurally supports the contacts 24, 36 during manufacturing and assembling of the connector 20. The tie bars 26 are then cut or stamped, as shown in FIG. 13B, after the contacts 24, 36 have been arranged in the first housing 32, and the first housing 32 can then be attached to the second housing 33. Further, as shown in FIGS. 13A and 13B, the contacts 24, 36 may be formed in various shapes.

FIG. 8B shows the board connection between some of the contacts 37 of the connector 20 and the substrate 40. Preferably, low-speed connections are used for low-frequency signals, control signals, power, or ground. As shown in FIG. 8B, these contacts 37 include the central pins 38 shown in FIGS. 5 and 7.

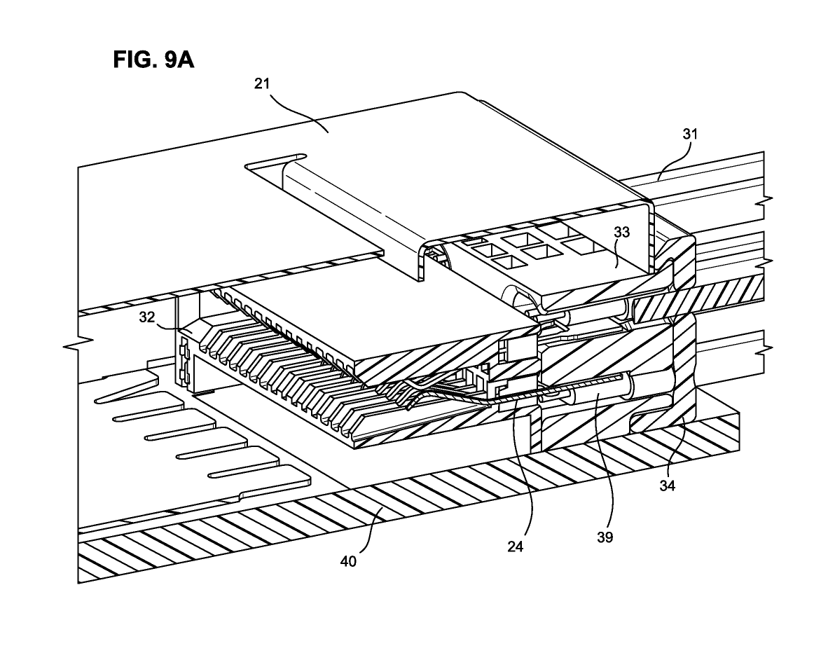

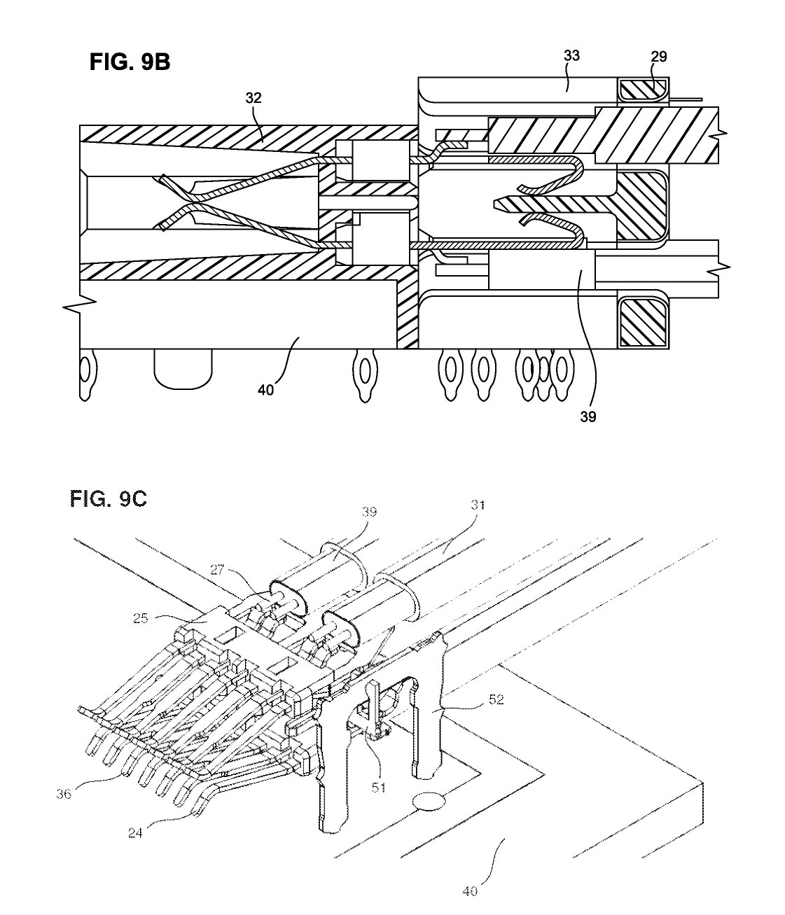

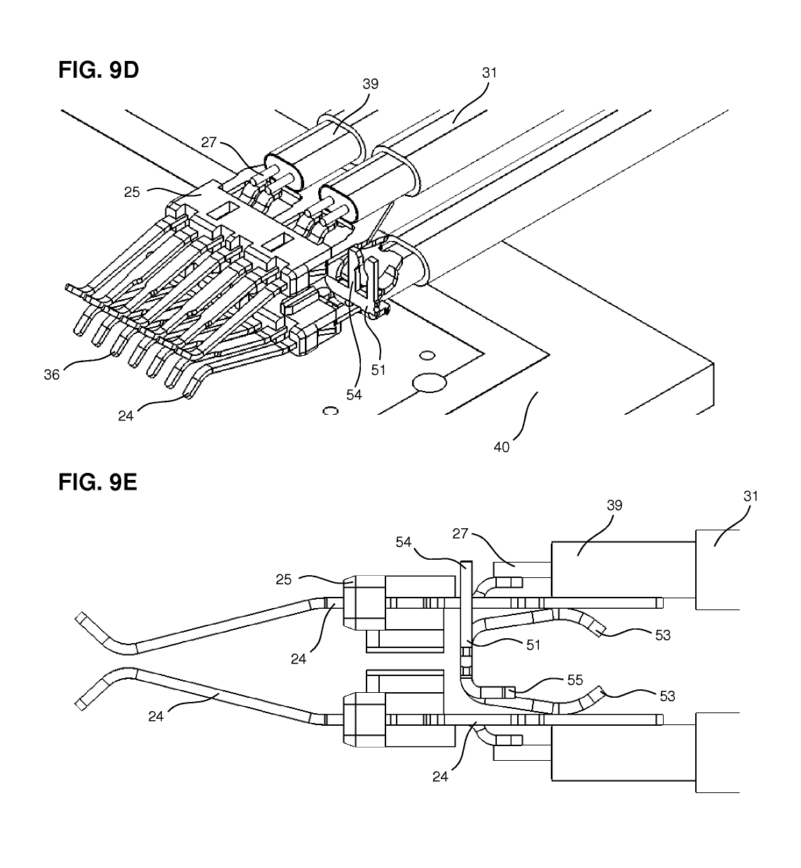

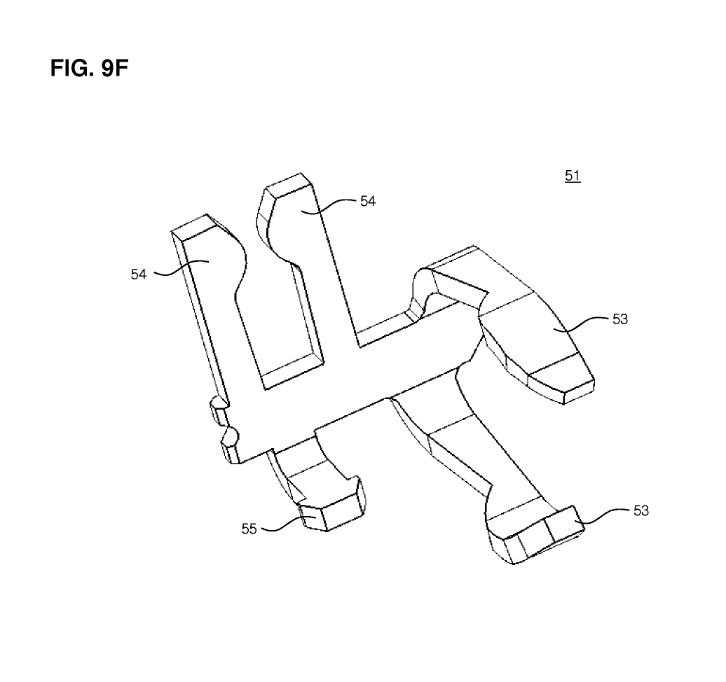

FIGS. 9A and 9B are cross-sectional views of ground connections for the connector 20 shown in FIGS. 3A and 4A. As shown in FIG. 9A, ground connections can be provided by contacts 24 similar to those shown in FIG. 8A that are connected to the shields 39 of the cables 31. However, other ground connections can be used. As shown in FIG. 9B, the contact 24 can be connected to the cage 21 through a tin-plated, die-cast grommet 29 of the second housing 33. The grommet 29 includes a hole such that there is a gap between the grommet 29 and the cables 31. According to the configuration shown in FIG. 9B, it is not necessary to include the grommet 34 in the second housing 33.

FIGS. 9C-9F shows another arrangement in which the contact 24 is grounded through a grounding pin 51 that is connected to both the contact 24 and a weld tab 52. The weld tab 52 is used to secure the second housing 33 to the substrate 40. The weld tab 52 is preferably press fit to the substrate 40 as shown in FIG. 9C but could also be soldered or welded to the substrate 40. The weld tab 52 preferably is inserted into both the first and second housings 32, 33 to secure both the first and second housings 32, 33 to the substrate 40. For clarity, FIG. 9C only includes four cables 31 and does not include the cage 21, the first housing 32, and the second housing 33. FIG. 9D is similar to FIG. 9C except that the weld tab 52 is not included so that more of the grounding pin 51 can be seen. FIG. 9E is a side view that does not include the substrate 40. FIG. 9E shows the arms 53 of the grounding pin 51 in contact with two contacts 24. FIG. 9F only shows the grounding pin 51. Grounding pin 51 includes two arms 54 that engage with the weld tab 52, arms 53 that engage with the contacts 24, and arm 55 that engages with the second housing 33 to secure the grounding pin 51 to the second housing 33.

Instead of the cables 31 being directly attached to the connector as discussed above, an interface can be added to the back of the connector so that a cable assembly can be plugged into the interface. Any suitable interface can be used.

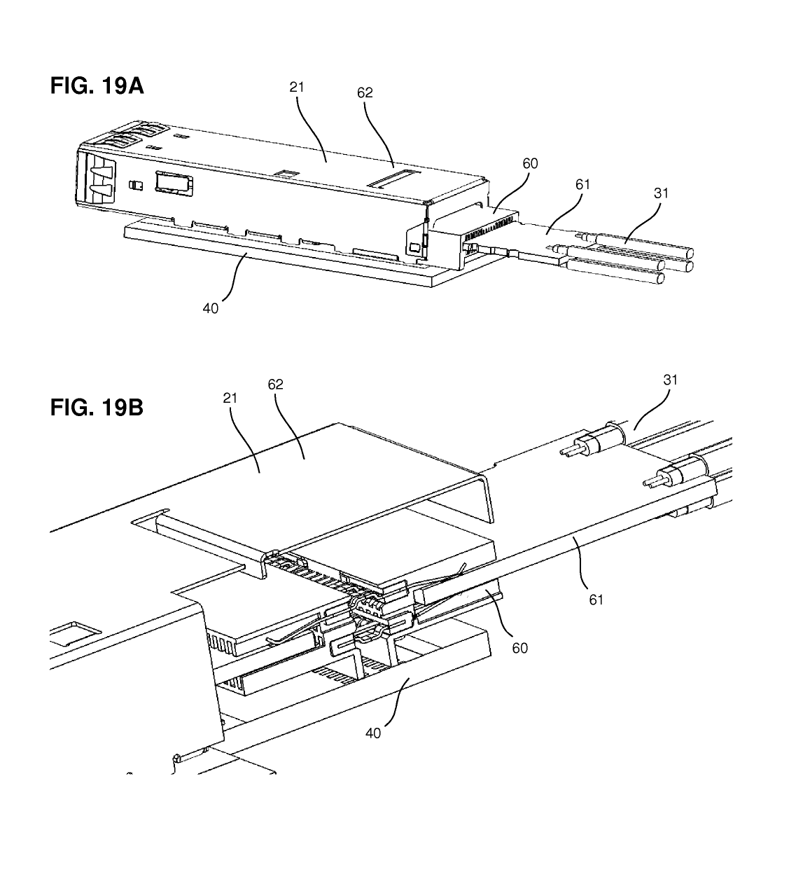

FIGS. 19A and 19B show a connector 62 in which the interface is an edge-card connector 60. The cables 31 are connected to an edgecard 61. The edgecard 61 is inserted into the edge-card connector 60.

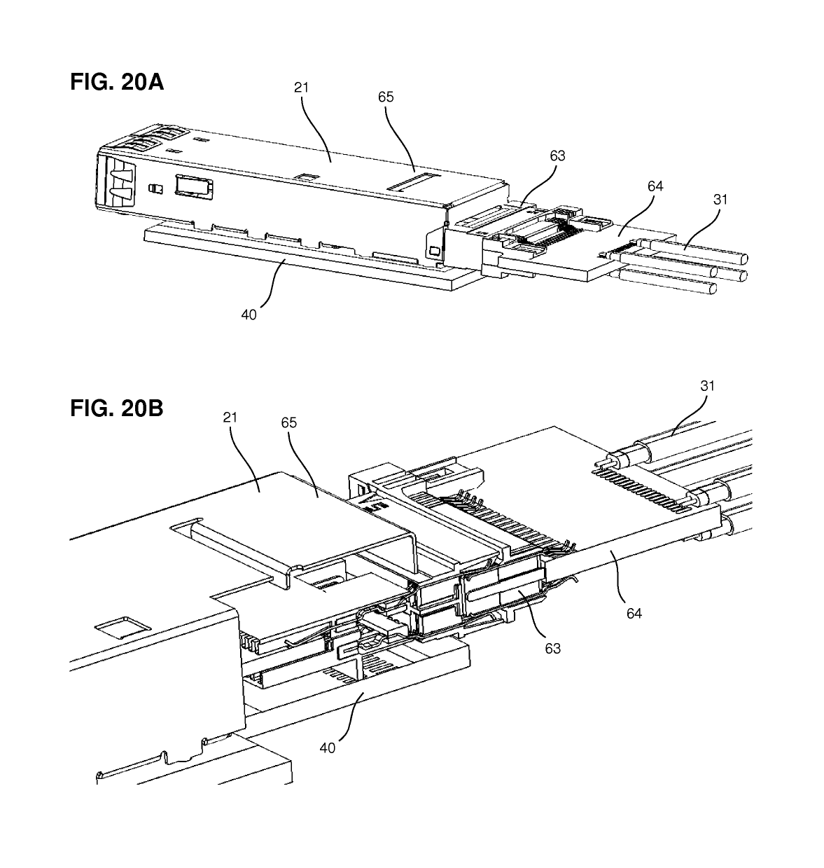

FIGS. 20A and 20B show a connector 65 in which the interface is an edge-rate connector 63. The cables 31 are connected to a substrate 64. The substrate 64 is inserted into the edge-rate connector 63.

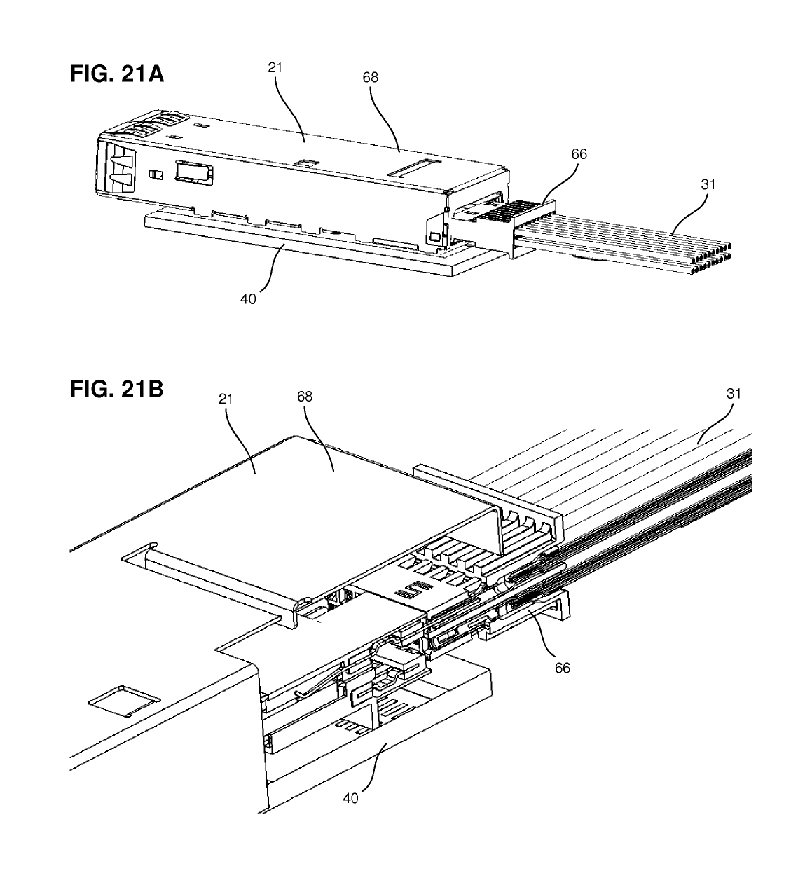

FIGS. 21A and 21B show a connector 68 in which the interface is a pin-and-socket connector 66. The cables 31 are connected to pin-and-socket connector 63.

An interface, including, for example, an edge-card connector, an edge-rate connector, and a pin-and-socket connector, as shown in FIGS. 19A-21B, can also be added to the vertical connector shown in FIGS. 3B and 4B.

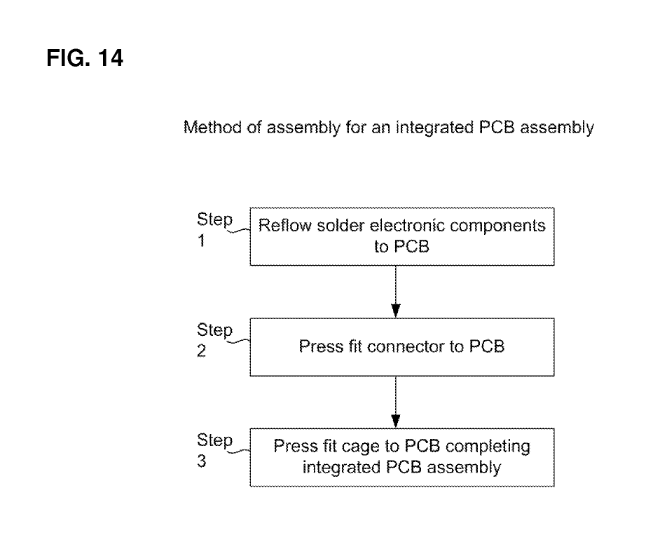

FIG. 14 is a diagram showing a method of assembly for an integrated PCB assembly. The method shown in FIG. 14 can be used, for example, to assemble a PCB assembly that includes the connector shown in FIGS. 3A and 4A attached to a PCB.

As shown in step 1, electrical components (for example, ICs, capacitors, and the like) may be attached to the PCB using a standard reflow solder process before the connector is attached. That is, the electrical components may be surface-mount components. However, the electrical components may alternatively be attached to the PCB by press-fit connections. As shown in step 2, the connector is then press-fit to the PCB. The IC connector may also be press-fit to the PCB in step 2. Press-fitting the connector(s) to the PCB provides sufficient electrical and mechanical connections between the connector(s) and the PCB to ensure that the connector(s) are mechanically retained by the PCB and to provide a low-loss path between the contacts of the connectors and the corresponding mounting holes of the PCB.

By using a press-fit connection to connect the connector(s) to the PCB, it is not necessary for the connector(s) and cables to be compatible with solder reflow processes. Accordingly, a wide range of materials may be used to form the connector(s) and cables, including materials that are unsuitable for solder reflow processes. However, instead of a press-fit connection, the connector(s) may be attached to the PCB using other types of connections, including fusible connections such as solder. In addition, the connectors can use same solder as the solder that is used to assemble the PCB. Specifically, the connectors may alternatively be attached to the PCB as surface-mount components.

As shown in step 3, the cage is then press-fit to PCB.

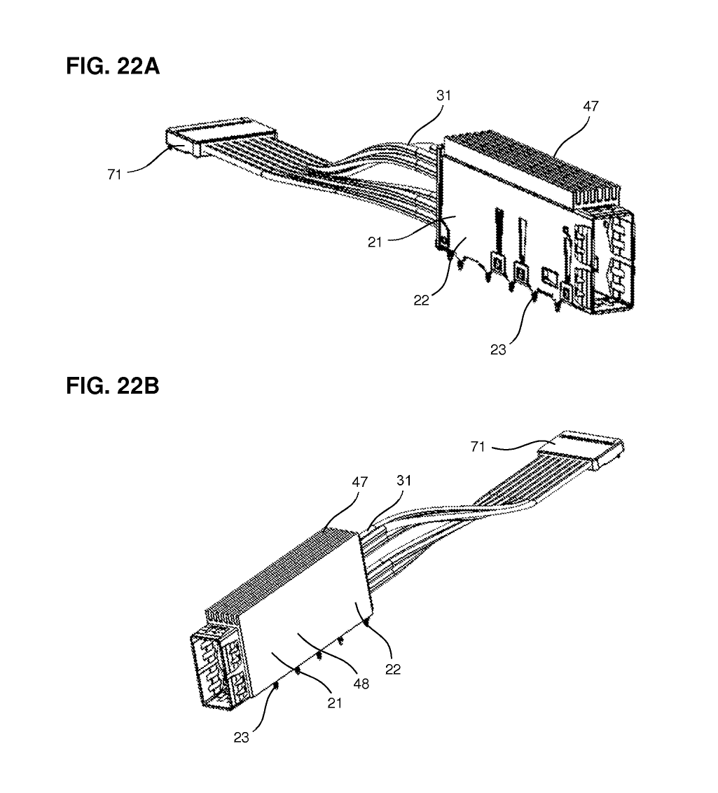

Furthermore, other components, such as heat sinks, may be added to the integrated PCB assembly prior to, during, in between, or after any of the steps shown in FIG. 14. An example of a heat sink 47 is shown in FIGS. 22A and 22B. The heat sink 47 in FIGS. 22A and 22B is added to a vertical connector; however, a heat sink can also be added to the connector shown in FIGS. 3A and 4A. The heat sink 47 shown in FIGS. 22A and 22b is preferably biased to one side with wall 48 only extending down one side of the connector 22. However, other arrangements are also possible, including, for example, a symmetrical heat sink.

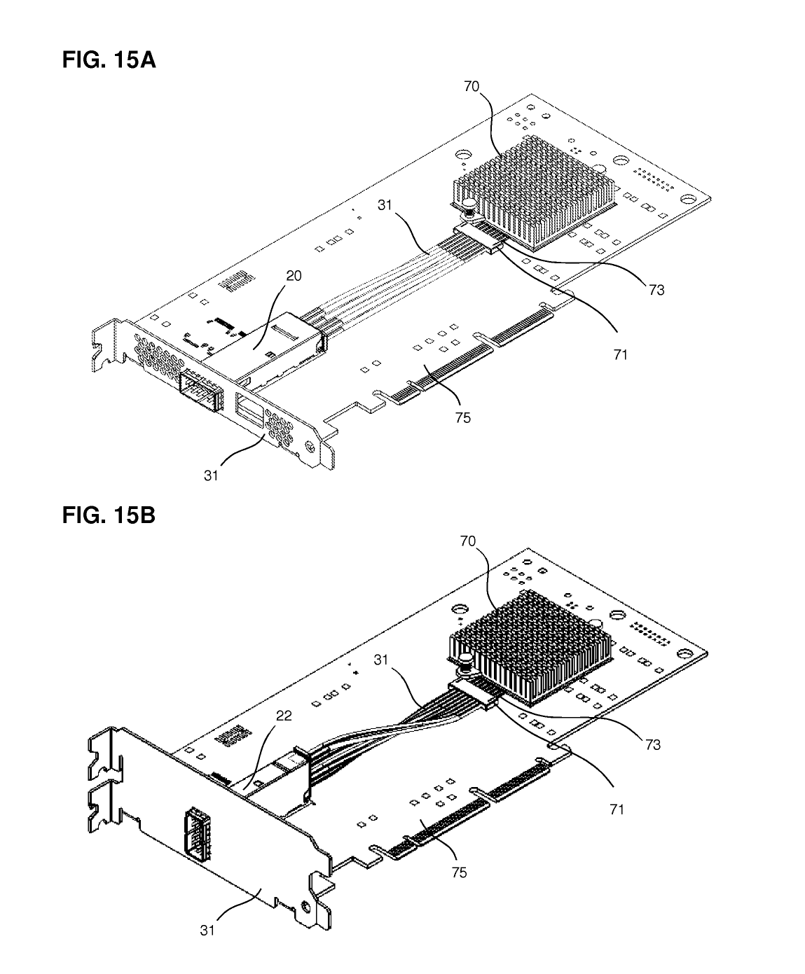

FIG. 15A is a perspective view of the connector 20 shown in FIGS. 3A and 4A attached to a substrate 75 that includes a panel 72, an IC 70, and an IC connector 71. The IC connector 71 is preferably connected to the IC 70 by traces 75. The IC connector 71 and the IC 70 can be connected by any suitable structures, including, for example, microstrips and striplines. The IC 70 preferably includes a heat sink as shown in FIG. 15A but a heat sink is not necessary. FIG. 15B is a similar to FIG. 15A except that the vertical connector 22 shown in FIGS. 3B and 4B is used instead of the connector 20 shown in FIGS. 3A and 4A.

The IC connector 71 is preferably a connector that provides a direct or nearly direct attachment between the cables 31 and the substrate 75. The IC connector 71 is preferably a direct-attach connector cable, such as the one described in co-pending U.S. application Ser. No. 14/551,590, hereby incorporated in its entirety by reference.

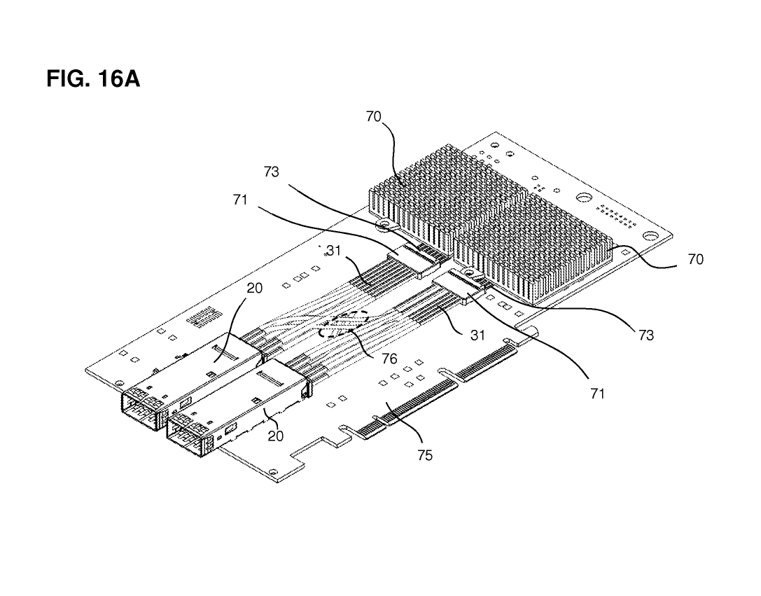

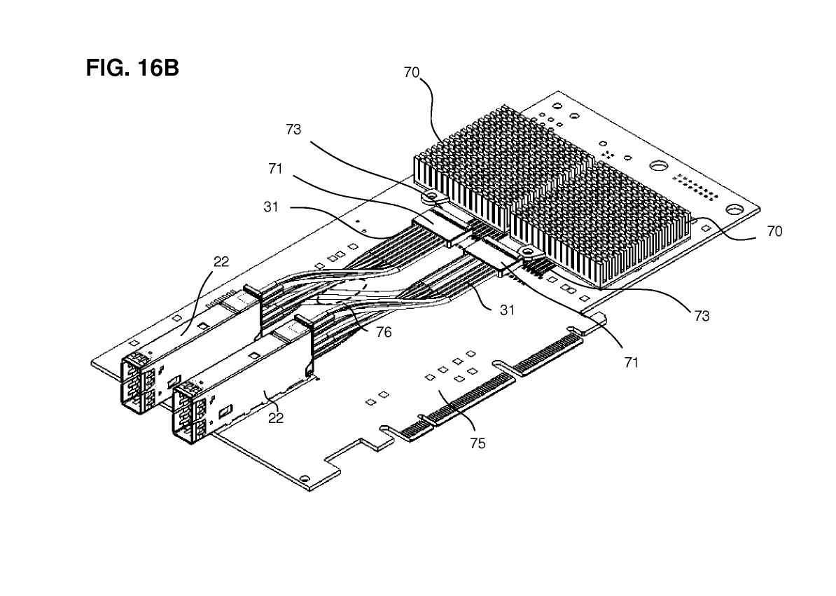

FIG. 16A is a perspective view of two of the connectors 20 shown in FIGS. 3A and 4A attached to a substrate 75 that preferably includes two ICs 70 and two IC connectors 71, for example. FIG. 16B is a similar to FIG. 16A except that two vertical connectors 22 shown in FIGS. 3B and 4B are used instead of two connectors 20 shown in FIGS. 3A and 4A.

The two connectors 20 or 22 can be attached along an edge of the substrate 75. Each of the connectors 20 or 22 includes a corresponding set of cables 31. The connectors 20 or 22 can be directly connected to corresponding IC connectors 71, or the connectors 20 or 22 can have cables 31 that are connected to both of the IC connectors 71. The substrate 75 can include a crossover region 76 where cables 31 cross over to transmit signals to different IC connectors 71. Accordingly, signals from multiple connectors can be distributed to multiple ICs with low loss and minimal cross talk between the various channels.

The preferred embodiments of the present invention are preferably compatible with the QSFP specifications. That is, a connector according to preferred embodiments of the present invention is preferably a female connector that is able to mate with a QSFP male connector. However, a connector according to preferred embodiments of the present invention does not include connections to a substrate or PCB that comply with the QSFP specifications. According to the QSFP specifications, each of the contacts included in a female QSFP connector are directly connected to a corresponding pad on a substrate or PCB. The pads on the substrate or PCB are then connected to traces formed in the substrate or PCB. In contrast, according to preferred embodiments of the present invention, some of the contacts within a QSFP connector are directly mated to a substrate or PCB, while the remaining contacts are mated to shielded cables.

Accordingly, by transmitting certain signals, such as high-frequency signals, by shielded cables rather than by traces of a substrate or PCB, board-layout flexibility, high bandwidth, and low crosstalk is reliably achieved. Further, long routing paths to components mounted on a substrate or PCB, such as an IC, may be used, since a high degree of signal integrity is maintained by the use of shielded cables for the high-frequency signals.

For example, as compared with the overall data transfer rate of 40 Gbit/sec of conventional QSFP connectors, a QSFP connector according to preferred embodiments of the present invention provide overall data transfer rates of 100 Gbit/sec or more. Specifically, according to preferred embodiments of the present invention, data transfer rates of 28 Gbit/sec are achieved in each of the four channels.

Furthermore, because high-frequency signals are transmitted through shielded cables rather than through traces in the substrate, it is not necessary for the substrate to be formed of special materials. That is, because the dielectric properties of the substrate are not critical due to frequency signals being transmitted through shielded cables, the substrate may be formed of standard PCB materials, such as FR-4. Further, the substrate may be formed of other materials, for example, Megtron™ from Panasonic Inc., Nelco™ from Park Electrochemical Corp., Rodgers™ from Sunstone Circuits Inc., and the like.

Specifically, the preferred embodiments of the present invention are preferably configured to be used with the QSFP+28 specification to augment the SFF-8672 specification for Small Form Factor pluggable connector systems running at 28 Gbit/s. Preferred embodiments of the present invention are also applicable to the other speed ratings including QSFP+14, QSFP+10, and QSFP+, which are respectively defined by the SFF-8672, SFF-8682, and SFF-8436 specifications. These specifications represent a class of backward-compatible, module-plug connector systems, which provide increased performance with each subsequent generation. The preferred embodiments of the present invention can be applied to any of these specifications and are preferably compatible with future higher speed specifications and applications.

In addition, the preferred embodiments of the present invention are not limited to QSFP+ related specifications and systems, but can also be applied to similar pluggable-module systems, such as CXP and HD, which are respectively defined by the SFF-8647 and SFF-8644 specifications.

The cables may include various different wire gages for the conductors of the cables; however, the cables preferably have conductor gages between 24 AWG and 34 AWG. Cables with lower gauge conductors have less flexibility but lower transmission losses, while cables with higher gauge conductors have more flexibility but higher transmission losses. Accordingly, higher data transfer rate applications may benefit from use of lower gauge cables, since they have lower transmission losses. However, if lower data transfer rates are acceptable, higher gauge cables may be used to permit greater flexibility in IC placement and overall PCB layout.

Preferably, the characteristic impedance of the cables is chosen to match those of the mating components, since matching impedances reduces unwanted reflections of high-frequency signals. Preferably, the impedance values for the cables are in the range of about 80Ω to about 100Ω, for example.

According to preferred embodiments of the present invention, high-speed cables may be attached directly to an IC, instead of being connected to the IC through the PCB. An interconnect, other than through the PCB, may be included between the high speed cables and IC. The preferred embodiments of the present invention can be applied to any system currently in use or being developed that requires high-bandwidth data transfer from a connector to an IC. According to preferred embodiments of the present invention, integrated PCB assemblies may be used as a line card, mother board, PCB control assembly, or some other element in a digital electronic system. The preferred embodiments of the present invention can be used with many data transfer formats including, for example, InfiniBand, Gigabit Ethernet, Fibre Channel, SAS, PCIe, XAUI, XLAUI, XFI, and the like.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1. A connector system comprising:
a substrate;
a first connector connected to the substrate and including:
a first housing;
a second housing; and
a cage surrounding the first and second housings;
first cables connected to the second housing and the substrate;
first contacts located in the first housing and directly connected to substrate; and
second contacts located in the first housing and connected to the first cables.

2. The connector system of claim 1, further comprising third contacts located in the first housing and connected to ground.

3. The connector system of claim 2, wherein:
the first cables have shields; and
the third contacts are connected to the shields.

4. The connector system of claim 1, wherein the first connector further includes a weld tab.

5. The connector system of claim 4, further comprising third contacts located in the first housing and connected to ground, and a grounding pin connected to one of the third contacts and the weld tab.

6. The connector system of claim 4, wherein the weld tab is located in the first and second housings.

7. The connector system of claim 1, wherein the second contacts are directly connected to the first cables.

8. The connector system of claim 1, further comprising an IC located on the substrate.

9. The connector system of claim 8, wherein the first cables are connected to the substrate next to the IC.

10. The connector system of claim 8, further comprising an IC connector located on the substrate next to the IC.

11. The connector system of claim 10, wherein the first cables are connected to the IC connector.

12. The connector system of claim 1, wherein the first connector is compatible with QSFP specifications.

13. The connector system of claim 1, further comprising:
a second connector; and
second cables connected to the second connector.

14. The connector system of claim 13, further comprising:
a first IC;
a first IC connector;
a second IC; and
a second IC connector; wherein
at least one of the first cables is connected to the first IC connector;
at least one of the first cables is connected to the second IC connector;
at least one of the second cables is connected to the first IC connector; and
at least one of the second cables is connected to the second IC connector.

15. The connector system of claim 1, wherein the first connector is a vertical connector.

16. The connector system of claim 1, wherein the second contacts are connected to the first cables through a connector substrate.

17. The connector system of claim 1, wherein the second housing includes one of an edgecard connector, an edge-rate connector, or pin-and-socket connector.
